(19) United States
(12) Patent Application Publication
(10) Pub. No.: US 2006/0157462 A1
(43) Pub. Date: Jul. 20, 2006

(54) Heat enhancement in critical viewing area of transparent plastic panel

(76) Inventors: Keith D. Weiss, Fenton, MI (US); Rebecca Northey, Portage, MI (US); Robert Schwenke, Fowlerville, MI (US); Kenneth Foster, Brighton, MI (US)

Correspondence Address: BRINKS HOFER GILSON & LIONE, P.O. BOX 10395, CHICAGO, IL, 60610, US

(21) Appl. No.: 11/299,015

(22) Filed: Dec. 9, 2005

Related U.S. Application Data
(60) Provisional application No. 60/635,106, filed on Dec. 10, 2004.

(51) Int. Cl. B60L 1/02

(52) U.S. Cl. 219/203

(57) ABSTRACT

A plastic window and defroster assembly that enhances the amount of heat generated in the critical viewing area of a transparent plastic glazing panel. The assembly includes a transparent plastic panel and a conductive heater grid formed by printing a conductive ink with a sheet resistivity of less than about milliohms/square @ 25.4 μm (1 mil).

### RELATED APPLICATION

This application claims the benefit of U.S. Provisional Application No. 60/635,106, filed Dec. 10, 2004, the entire contents of which are incorporated herein by reference.

### BACKGROUND OF THE INVENTION

Multiple differences exist between the type of conductive materials that are suitable for use in a heater grid designed for a glass panel or window as compared to a heater grid designed for a plastic panel or window. In particular, the manufacturing process for a glass panel or window allows the conductive metallic paste used to form the heater grid to be sintered at a high temperature (>300° C.). The exposure of the metallic paste to a high temperature allows for the metallic particles in the paste to soften and fuse together, thereby, resulting in sintered grid lines that exhibit a relatively high level of conductivity or low electrical sheet resistivity (S.R.≦2.5 milliohms/square @ 25.4 μm [1 mil]). In addition, this sintering process can create oxide surface functionality which allows for adequate adhesion of the sintered metallic grid lines to the surface of the glass panel or window.

In comparison, the glass transition temperature (T_{g}) exhibited by most polymer systems is far below a 300° C. process temperature. Thus a plastic panel or window cannot be exposed to the relatively high temperatures found in a glass panel or window manufacturing process. For a plastic panel or window the conductive metallic pastes can typically be exposed to a temperature that is lower by about 10° C. or more than the T_{g} exhibited by the plastic panel. For example, polycarbonate has a T_{g} on the order of 140° C. In this case, a cure temperature for the metallic paste should not exceed about 130° C. At this low temperature the metallic particles do not soften or fuse together. In addition, in order to adhere to the plastic panel or window, a polymeric phase must be present in the conductive paste. This polymeric material will inherently behave as a dielectric between the closely spaced metallic particles. Thus, the electrical conductivity exhibited by a cured metallic paste will be lower than that exhibited by a sintered paste.

Due to the lower electrical conductivity exhibited by conductive pastes cured on plastic substrates as compared to sintered metallic pastes printed on high temperature substrates (e.g., glass), as well as the lower thermal conductivity exhibited by plastics as compared to glass, heater grid functionality severely suffers when long grid lines are required. There is a need in the industry to enhance and optimize the amount of heat generated and dissipated in the critical viewing area in order to provide acceptable defrosters for the backlights, the rear windows, of large vehicles.

### BRIEF SUMMARY OF THE INVENTION

This invention provides for the enhancement of the amount of heat generated in the critical viewing area of a plastic window assembly. One embodiment of the present invention describes a plastic window assembly comprising a transparent plastic panel, at least one protective layer, and a conductive heater grid formed by printing a “highly conductive” ink, where the printed “highly conductive” ink is cured so as to exhibit a sheet resistivity less than about 8 milliohms/square @ 25.4 μm (1 mil). In another aspect, the present invention includes a heater grid having a primary grid line exhibiting a resistance of less than about 30 ohms and an overall resistance for the entire heater grid of less than about 1 ohm. In yet another aspect, the present invention describes the enhancement of the amount of current flowing through a primary grid line by either using a “variable width” approach, a “converging line” approach, or a “crossing line” approach.

The present invention also describes a method of defrosting and defogging the surface of a plastic window assembly. According to the method, the application of voltage to a printed conductive heater grid causes electrical current to flow through primary grid lines of a conductive heater grid; the flow of electrical current through the primary grid lines causing the resistive heating of the primary grid lines of the heater grid; the resistive heating of the primary grid lines causing the surface of a transparent plastic glazing panel to defrost and defog; the flow of electrical current through a primary grid line is provided so as to be greater than about 0.4 amps and the ratio of current density to resistance for a primary grid line is to be greater than about 1 amp/ohm-mm² and disconnecting the voltage from the heater grid after the surface of the transparent plastic panel is defrosted and defogged or after a defined time interval.

### BRIEF DESCRIPTION OF THE DRAWINGS

FIG. 1 is a graph of surface temperature versus time necessary to defrost 75% of the visual area of a 4 mm thick polycarbonate window using the SAE J953 (1999) automotive industry standard;

FIG. 2 illustrates cross-sectional schematics depicting various possible constructions for plastic window assemblies embodying the present invention;

FIG. 3 is a graph comparing the temperature output of a 0.6 mm wide grid line as a function of the electrical current flowing through the grid line, the grid line being either a conventional conductive ink on a plastic substrate, a “highly” conductive ink on a plastic substrate, or a frit-type ink sintered on a glass substrate.

FIG. 4 is a graph comparing the temperature output of grid lines of various widths as a function of electrical current allowed to flow through the grid lines, the grid lines being of a “highly” conductive ink;

FIG. 5 is a plot of current density versus grid line resistance for grid lines of “highly” conductive inks and of conventional conductive inks, at temperature outputs of 40° C., 50° C., 60° C., and 70° C.

FIG. 6 is a plot of grid line resistance versus grid line volume for grid lines of “highly” conductive inks and conventional conductive inks modeled using a Power Law Function;

FIG. 7 is a schematic illustration of grid lines, depicting the defrosting zones established thereby through using either (i) a “variable width” approach or (ii) a “converging line” approach in comparison to (iii) a “conventional” approach;

FIGS. 8A and 8B are schematic illustrations of heater grids with a “crossing line” approach to enhance the current in the critical viewing area;

FIG. 9 is a schematic of a heater grid that enhances the current in the critical viewing area using a the “variable width” approach; and

FIG. 10 is a schematic of a heater grid that enhances the current in the critical viewing area using a “variable width” approach and a “converging line” approach.

### DETAILED DESCRIPTION OF THE INVENTION

This invention relates to a heater grid applied to a transparent plastic glazing panel such that the panel can be defrosted to meet accepted automotive defrosting standards in the form of the SAE J953 (1999) test protocol (Society of Automotive Engineers, Warrendale, Pa.), entitled “Passenger Car Backlight Defogging System”. In order to meet this test, the heater grid, when part of a plastic window assembly, utilizes one or more constructions for enhancing and optimizing the amount of heat generated in the critical viewing area of the window or panel. The first of these involves using a conductive metallic paste or ink that meets or exceeds specific requirements with respect to sheet resistivity exhibited by primary grid lines and overall electrical resistance exhibited by the heater grid design. Another incorporates the use of additional secondary grid lines in non-critical viewing areas that converge with and intersecting with the primary grid lines. Another construction utilizes a variable grid line width to enhance the heating profile of the primary grid lines in the critical viewing area.

The SAE J953 (1999) standard test as adopted by the automotive industry includes ten steps ranging from creating the frost or ice on the window to measuring the percentage of the visual area cleared as a function of time. The overall procedure is generally described in Table 1. A window comprising a heater grid that can defrost at least 75% of the viewing area in less than 30 minutes, according to this standard, is acceptable for use in an automotive application. However, many automotive manufacturers would prefer that a heater grid be capable of defrosting a window in a more narrowly defined time frame, such as 20 minutes, with less than 10 minutes being especially preferred.

TABLE 1

| | |
|---|---|
| 1. | Soak window for several hours at temperature at −18 to −20° C. |
| 2. | Spray window multiple times with water |
| 3. | Soak window for >1 hour additional time for water/ice to equilibrate |
| 4. | Insure window is in a vertical position |
| 5. | Monitor temperature & air movement (2.24 meter/second) |
| 6. | Turn defroster ON (apply 13.1 volts) |
| 7. | Record voltage, current, thermocouples (T) at time zero |
| 8. | Take measurements (picture, etc.) at “break- through & at least |
| | every 5 minutes |
| 9. | End test when 100% view area cleared or at 30 minutes |
| 10. | Analyze time required to clear 75% of view area |

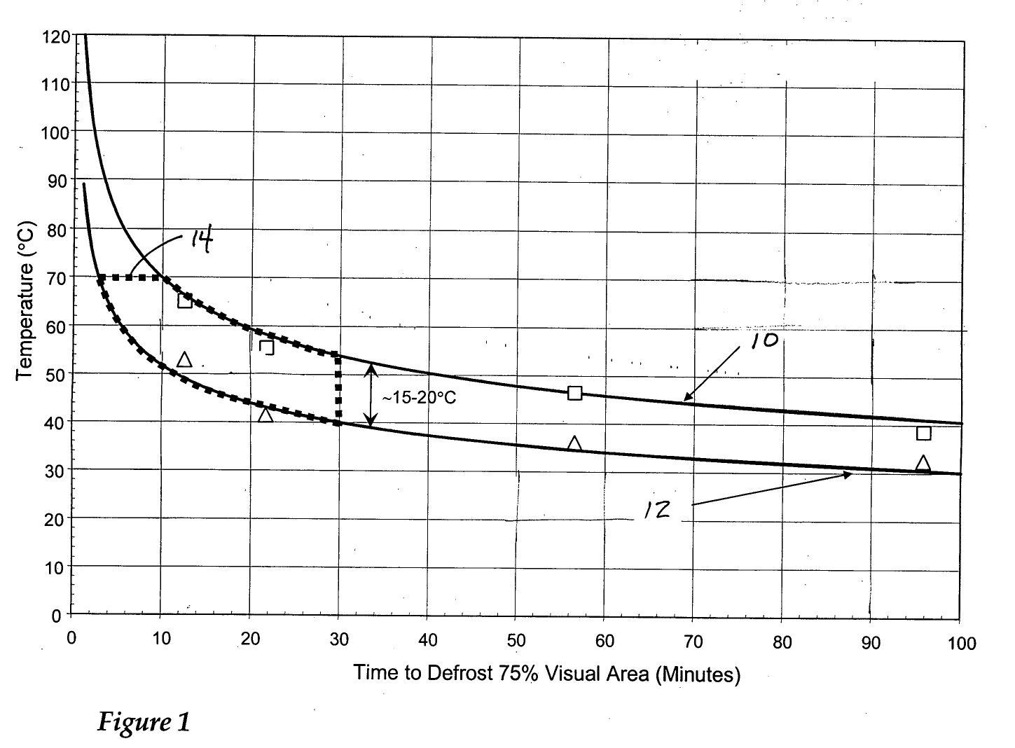

A heater grid designed for a plastic panel (polycarbonate, 4 mm thick) as described in U.S. Patent Publication 2005-0252908 A1, which is herein incorporated by reference, can meet the SAE J953 (1999) standard when the heater grid is positioned on the internal surface of the panel, while the ice to be defrosted resides on the opposite, external surface of the panel. With this heater grid, a primary grid line temperature of about 55° C. is capable of defrosting a plastic panel in 30 minutes. At about 60° C. defrosting occurs in 20 minutes and at about 70° C. defrosting occurs in 10 minutes. Shown in FIG. 1 are plots of the grid lines temperatures on the interior surface (the surface on which the heater grid is carried) of the plastic panel and the temperature of the exterior surface (the frosted surface) of the panel, respectively designated as plots 10 and 12. The grid line temperature measurements (thermal profile) were taken at an ambient environmental temperature (22.5° C.) for convenience. The temperature exhibited by the external surface of the plastic panel was also measured at an environmental temperature of 22.5° C. As seen in FIG. 1, the equilibrium temperature of the external plastic surface, that surface which was in contact with the ice or frost, was about 15-20° C. lower than the temperature of the grid lines on the internal surface of the plastic panel.

In order to defrost the plastic panel within 10, 20, or 30 minutes, the external surface temperature of the panel must reach about 50° C., 45° C., and 40° C., respectively. From this, thermal ratio can be defined as the internal surface temperature necessary to defrost the external surface of a plastic panel (as determined according to SAE J953 protocol) to an ambient environmental temperature of 22.5° C. Thus, in order to defrost a plastic panel within 10, 20, or 30 minutes, the primary grid lines and exterior surface must exhibit a thermal ratio of about 2.2, 2.0, and 1.8, respectively. The inventor's believe that the reason for the temperature difference between the grid line temperature (inside surface of panel) and the external surface temperature (outside surface of panel) is the relatively poor thermal conductivity or thermal diffusivity exhibited by plastic panels.

Using the test protocol, a preferred design area 14 for defrosting a plastic window for automotive applications can be depicted in FIG. 1 so as to establish a surface temperature external to the window, e.g., in contact with the frost or ice, that is between 40-70° C. Since the maximum temperature allowable for the primary grid lines and busbars in a heater grid on a plastic panel is 70° C., due to safety concerns, the position of the heater grid in relation to the external surface of the window is an important design consideration for optimizing the defrost and defog capability exhibited by the heater grid.

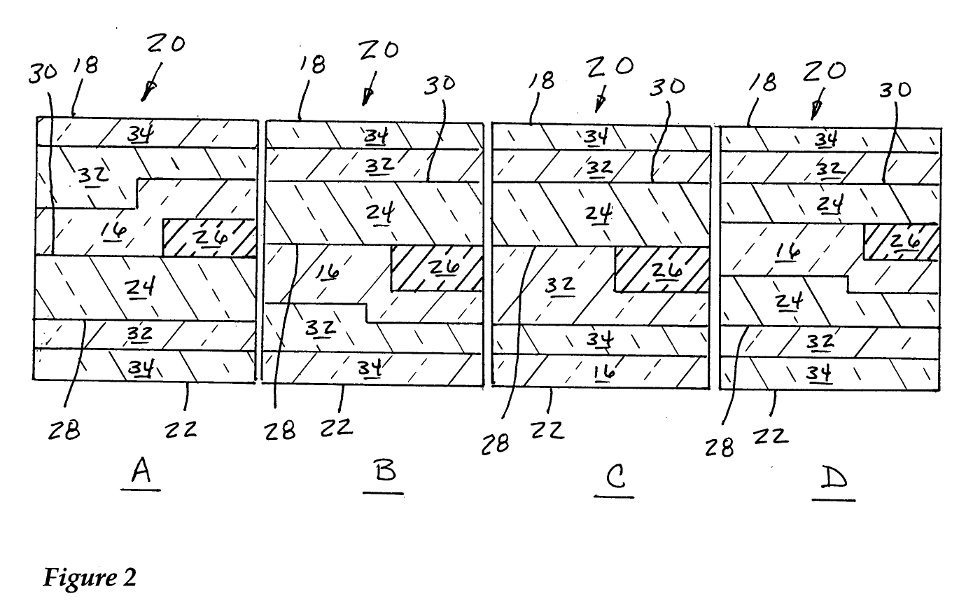

As seen in FIG. 2, a heater grid 16 may be positioned near the external surface 18 of the plastic window assembly 20 (Schematic A), on the internal surface 22 of the plastic window assembly 20 (Schematic B and C), or encapsulated within the plastic panel (Schematic D). Each of the possible positions for the heater grid 16 offers different benefits in relation to overall performance and cost. Positioning the heater grid 16 near the external surface 18 (Schematic A) of a plastic window assembly 20 is preferred to minimize the time necessary to defrost the plastic panel 24. Positioning the heater grid 16 on the internal surface 22 (Schematic C) of a plastic window assembly is preferred due to ease of application and lower manufacturing costs for the entire system.

The transparent plastic panel 24 may be comprised of any thermoplastic polymeric resin or a mixture or combination thereof. The thermoplastic resins may include, but are not limited to, polycarbonate resins, acrylic resins, polyarylate resins, polyester resins, and polysulfone resins, as well as copolymers and mixtures thereof. The transparent panels 24 may be formed into a window through the use of any known technique to those skilled in the art, such as molding, thermoforming, or extrusion. The transparent panels 24 may further comprise areas of opacity, such as a black-out border 26 and logos, applied by printing an opaque ink or molding a border using an opaque resin.

A heater grid 16 may be integrally printed directly onto the surface inner or outer 28, 30 of the plastic panel 24 or on the surface of a protective layer 32 using a conductive ink or paste and any method known to those skilled in the art including, but not limited to, screen-printing, ink jet, or automatic dispensing. Automatic dispensing includes techniques known to those skilled in the art of adhesive application, such as drip & drag, streaming, and simple flow dispensing.

The plastic panel 24 may be protected from such natural occurrences as exposure to ultraviolet radiation, oxidation, and abrasion through the use of a single protective layer 32 or additional, optional protective layers 34, both on the exterior side and/or interior side of the panel 24. A transparent plastic panel 24 with at least one protective layer 32 is defined herein as a transparent plastic glazing panel.

The protective layers 32, 34 may consist of a plastic film, an organic coating, an inorganic coating, or a mixture thereof. The plastic film may be of the same or different composition as the transparent panel. The film and coatings may comprise ultraviolet absorber (UVA) molecules, rheology control additives, such as dispersants, surfactants, and transparent fillers (e.g., silica, aluminum oxide, etc.) to enhance abrasion resistance, as well as other additives to modify optical, chemical, or physical properties.

Examples of organic coatings include, but are not limited to, urethanes, epoxides, and acrylates and mixtures or blends thereof. Some examples of inorganic coatings include silicones, aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, tantalum oxide, titanium oxide, tin oxide, indium tin oxide, yttrium oxide, zinc oxide, zinc selenide, zinc sulfide, zirconium oxide, zirconium titanate, or glass, and mixtures or blends thereof.

The coatings may be applied by any suitable technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include but are not limited to plasma enhanced chemical vapor deposition, ion assisted plasma deposition, magnetron sputtering, electron beam evaporation, and ion beam sputtering. Examples of atmospheric coating processes include but are not limited to curtain coating, spray coating, spin coating, dip coating, and flow coating.

As mentioned above, a heater grid may be placed near the internal or external surface 22, 18 of the window assembly 20 by application of the grid pattern onto the plastic panel, onto a protective layer 32, or between two protective layers. In one construction, the heater grid 16 may print onto the inner surface 28 of the plastic panel and beneath any and all protective layers 32, 34 (Schematic B), while another construction includes a heater grid 16 printed onto the surface of the innermost (interior of the vehicle) protective layer 34 (Schematic C). For example, a polycarbonate panel 24 comprising the Exatec® 900 automotive window glazing system with a printed defroster 16 corresponds to the embodiment of Schematic C. In this particular case, the transparent polycarbonate panel 24 is protected with a multilayer coating system (Exatec® SHP-9X, Exatec® SHX, and a deposited layer of a “glass-like” coating (SiOₓC_{y}H_{z}) that is then printed with a heater grid 16 on the exposed surface of the protective layer 34 facing the interior of the vehicle. As a further alternative construction, a heater grid 16 may be placed on top of a layer or layers of a protective coating or coatings 32, 34, then subsequently over-coated with an additional layer or layers of a protective coating or coatings. For instance, a heater grid 16 may be placed on top of a silicone protective coating (e.g., AS4000, GE Silicones) and subsequently over-coated with a “glass-like” film.

In the construction of Schematic A, the heater grid 16 is placed near the external surface 18 of the assembly 20, while yet another embodiment (Schematic D) places the heater grid 16 within the plastic panel 24 itself. These two embodiments may involve the initial application of the heater grid 16 to a thin film or panel of transparent plastic. The transparent film or panel may be subsequently thermoformed to the shape of the window and thereafter placed into a mold and exposed to a plastic melt, via injection molding, to form the plastic panel or window 20. The thin film and a transparent panel 24 or two transparent panels 24 may also be laminated or adhesively adhered together. The thin plastic panel 24 or film upon which the heater grid 16 is placed may also contain a decorative ink or black out border 26, as well as other added functionality.

In order for the primary grid-lines of a heater grid 16 to reach a temperature necessary to achieve acceptable defrosting and defogging performance (see FIG. 1), it has been found that a high conductivity paste or ink is necessary. Conventional conductive pastes or inks are very limited in their capability to function as a defroster for a plastic automotive window. Primarily, the relatively low conductivity exhibited by conventional conductive inks and pastes limits the length of a grid line to about 750 mm (˜30″) in order for the heater grid 16 to function appropriately. Unfortunately, most vehicle rear windows are wider than 750 mm and require a heater grid 16 with grid lines in excess of 750 mm. Examples of conventional conductive inks or pastes along with their associated manufacturer are shown in Table 2. As noted in Table 2, the sheet resistivity exhibited by conventional conductive inks or pastes is greater than or equal to 10.0 milliohms per square @ 25.4 μm (1 mil).

TABLE 2

| | | Sheet | |
|---|---|---|---|
| | | Resisitivty | |
| | | (milliohms | |
| | | per square | |
| | | @ 1 mil) | |
| | CONVENTIONAL | | |
| | INKS | | |
| 1 | CSS-015A | 20 | Precisia LLC (Ann Arbor. MI) |
| 2 | CSS-010A | 32-35 | Precisia LLC (Ann Arbor, MI) |
| 3 | AG-755 | 23 | Conductive Compounds |
| | | | (Londonderry, NH) |
| 4 | PI-2500 | 11-22 | Dow Corning Corp. (Midland, MI) |
| 5 | Electrodag ® | 20 | Acheson Colloids Co. |
| | PF-007 | | (Port Huron, MI) |
| 6 | Electrodag ® | 10 | Acheson Colloids Co. |
| | 28RF107 | | (Port Huron, MI) |
| 7 | Electrodag ® | 60 | Acheson Colloids Co. |
| | SP-405 | | (Port Huron, MI) |
| 8 | 118-09 | 19 | Creative Materials Inc. |
| | | | (Tyngsboro, MA) |
| 9 | PTF-12 A/B | 20 | Advanced Conductive Materials |
| | | | (Atascadero, CA) |
| 10 | Silver | >20 | Coates Screen (St. Charles, IL) |
| | 26-8204 | | |
| 11 | 5000 | 15 | DuPont Microcircuit Materials |
| | | | (Research Triangle Park, NC) |
| 12 | 5029 | 10 | DuPont Microcircuit Materials |
| | | | (Research Triangle Park, NC) |
| 13 | 5021 | 15-17 | DuPont Microcircuit Materials |
| | | | (Research Triangle Park, NC) |
| | INKS - PRESENT | | |
| | INVENTION | | |
| 1 | Exatec 3064 | 4-8 | Fujikura Kasei Co. Ltd. |
| | | | (Tokyo, JP) |
| 2 | Exatec 100/101 | 4-8 | Parelec Inc. (Rocky Hill, NJ) |
| 3 | Exatec 31-3A | 4-8 | Methode Development Company |
| | | | (Chicago, IL) |

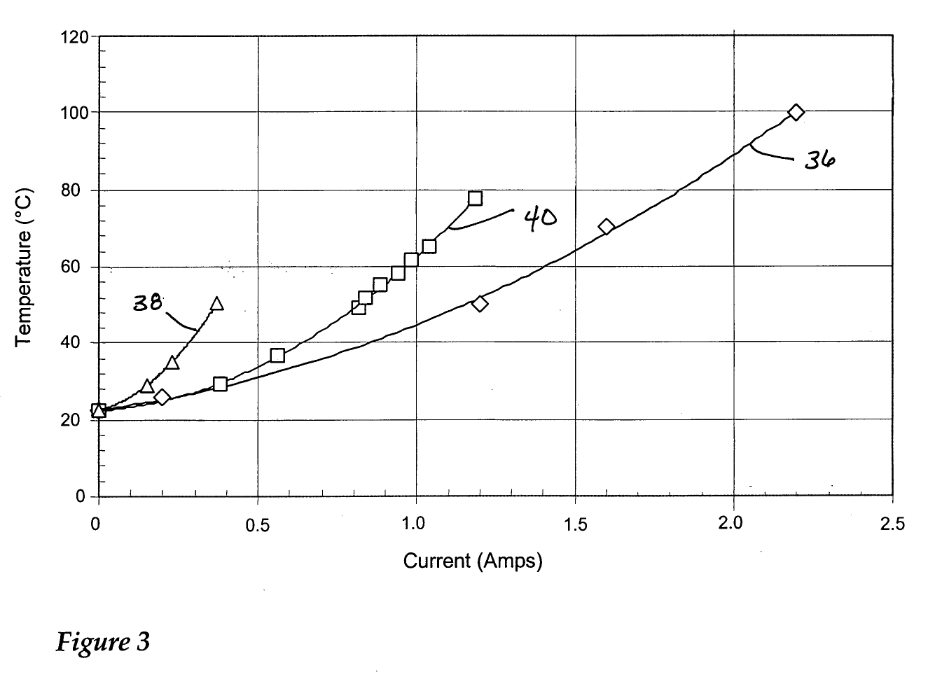

besting analyzing performance of various materials, an acceptable level of performance similar to that demonstrated by a printed & sintered grid line of a defroster made for a glass window. On the other hand, an unacceptable performance is viewed as that exhibited by conventional silver pastes or inks as previously described. A comparison of the performance of various types of grid lines, having a width of 0.6 mm, a height of about 8-10 μm, and a length of about 1000 mm (˜35″), is shown in FIG. 3. The sintered grid line on the glass window, plot 36, requires about 0.85 amps of current flow to achieve a temperature of about 40° C. In comparison, a grid line of similar dimensions comprising a conventional ink printed on a polycarbonate surface, plot 38, requires only about 0.28 amps to reach about 40° C. The primary reason for this occurrence is believed to be due to high sheet resistivity exhibited by the ink printed on polycarbonate (greater than 10 milliohms/square @ 25.4 μm (1 ml) verses that on glass (less than 2.5 milliohms/square @ 25.4 μm (1 ml)). In resistive heating, the amount of heat generated is highly dependent upon the amount of current flowing through the grid and the resistance of the grid line. A more resistive grid line will require a smaller amount of current to generate the necessary temperature, however, it will also require, as described by Ohm's Law, a larger amount of voltage to establish the current.

The inventor's have found that a certain type of conductive inks or pastes, when used on a plastic panel can lead to performance that more closely resembles the performance observed for a sintered ink on a glass panel. The inventor's have discovered that a “high conductivity” printed ink, exhibiting a sheet resistivity less than about 8 milliohms/square @ 25.4 μm (1 mil), and preferably less than about 6 milliohms/square @ 25.4 μm (1 mil), can be used make a functioning defroster on a plastic panel with grid lines in excess of 750 mm (30′). As shown in plot line 40 FIG. 3, a grid line (having a width of 0.6 mm and prepared using a “high conductivity” ink) requires just greater than about 0.6 amps of current to achieve the minimum temperature of 40° C. The more preferable temperatures of 50° C. and 60° C. are achievable when greater than about 0.8 amps and 1 amp, respectively, flows through the grid line.

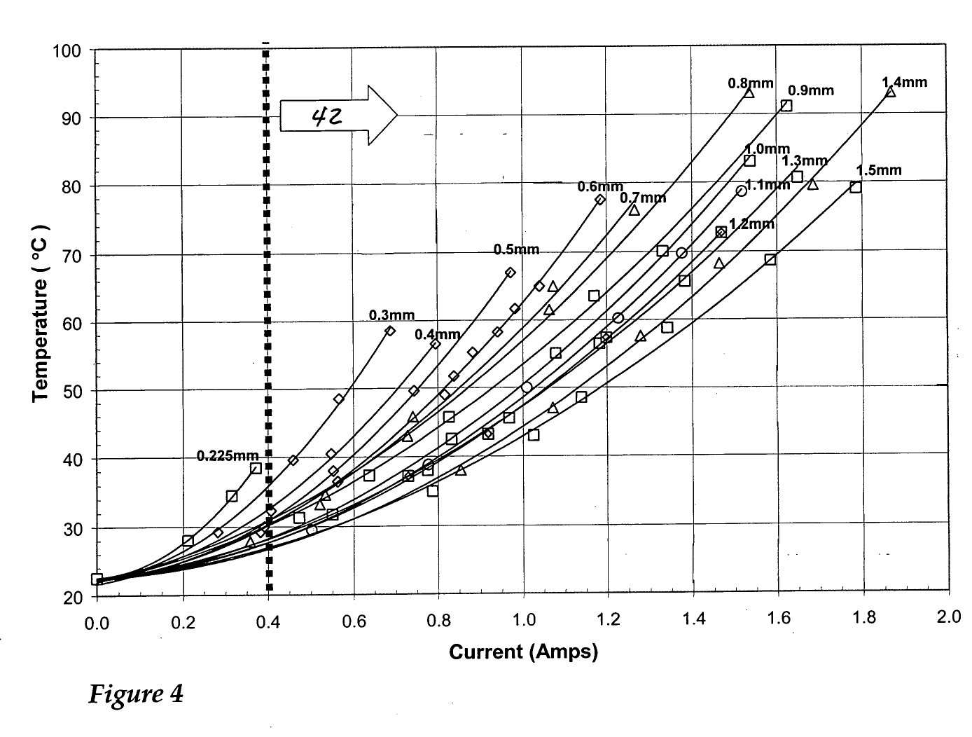

Upon connecting a typical automobile 12 volt (13.1 volt expected output) battery to the grid lines of a “high conductivity” ink, having a width of about 0.225 mm or greater, the minimum temperature of 40° C. can be achieved when the flow of current through the grid line is greater than about 0.4 amps, as shown in FIG. 4. The more preferable temperature of 50° C. can be achieved when the current flowing through a “high conductivity” ink grid line of slightly greater width, a width of greater than about 0.3 mm, is increased to greater than about 0.6 amps. The even more preferable temperature of 60° C. can be achieved when the current flow through a “high conductivity” ink grid line with a width greater than about 0.5 mm is greater than about 0.85 amps. The maximum temperature of 70° C. can be achieved when the current flow through a “high conductivity” grid line with a width greater than about 0.6 mm is greater than about 1 amp. Accordingly, a preferred design criteria for such “high conductivity” inks, designated by arrow 42 in FIG. 4, is greater than 0.4 amps and width of at least 0.225 mm.

The “high conductivity” inks may be comprised of conductive particles (e.g., flakes or powders) dispersed in a carrier medium. The “high conductivity” inks may further comprise a polymeric binder, including but not limited to an epoxy resin, a polyester resin, a polyvinyl acetate resin, a polyvinylchloride resin, a polyurethane resin or mixtures and copolymers of the like. Various other additives, such as dispersants, thixotropes, biocides, antioxidants, metallic salts, metallic compounds, and metallo-decomposition products to name a few, may be present in the “high conductivity” inks. Some examples of metallic salts and metallic compounds include tertiary fatty acid silver salts, metallic carbonate, and metallic acetate compounds. Some examples of metallo-organic decomposition products include carboxylic acid metallic soaps, silver neodecanoate, and gold amine 2-ethylhexanoate. Further examples of “high conductivity” inks, as well as a further description of metallic salts, compounds, and decomposition products are identified in European Patent No. 01493780, US Patent Publication 2004/0248998, and U.S. Pat. Nos. 5,882,722, 6,036,889, 6,379,745, and 6,824,603, the entirety of which are hereby incorporated by reference.

The conductive particles present in the “highly” conductive paste or ink applicable to the present invention may be comprised of a metal, including but not limited to silver, silver oxide, copper, zinc, aluminum, magnesium, nickel, tin, or mixtures and alloys of the like, as well as any metallic compound, such as a metallic dichalcogenide. These conductive particles, flakes, or powders may also comprise some conductive organic materials known to those skilled in the art, such as polyaniline, amorphous carbon, and carbon-graphite. Although the particle size of any particles, flakes, or powders may vary, a diameter of less than about 40 μm is preferred, with a diameter of less than about 1 μm being specifically preferred. A mixture of particle types and sizes may be utilized to enhance conductivity and lower sheet resistivity by optimizing particle packing. Any solvents, which act as the carrier medium in the “high conductivity” pastes or inks, may be a mixture of any organic vehicle that provides solubility or dispersion stability for the organic resin, additives, or conductive particles.

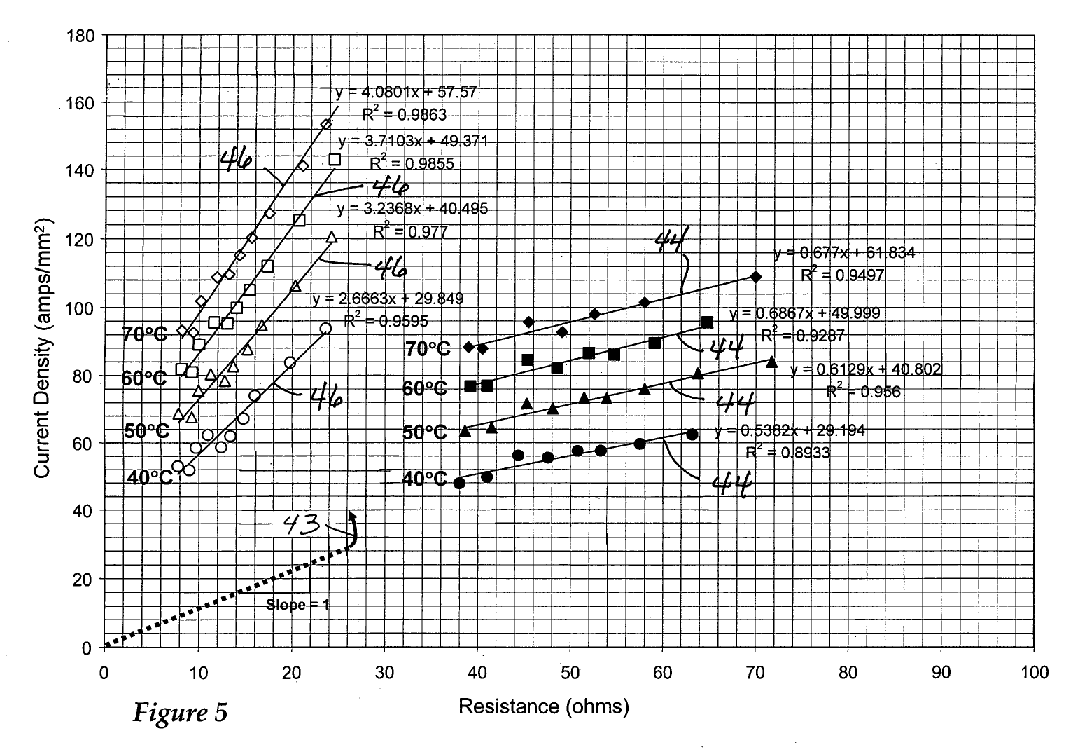

The inventors have discovered that for the “highly conductive” inks applicable to the present invention, a ratio of current density (current passing through the cross-sectional area of a grid line given in units of amps/mm²) to the resistance of the grid line is preferred to be greater than about 1 amp per ohm-mm², with greater than about 2 amps per ohm-mm² being preferred, as shown by the dotted line and arrow 43 in FIG. 5. In addition, each grid line should exhibit an electrical resistance (R) less than about 30 ohms. The current density and resistance are known electrical properties of both materials and circuit design that are capable of being easily measured by anyone skilled in the art. A plot of current density versus resistance for grid lines exhibiting various temperatures between 40° C. and 70° C. comprised of conventional conductive inks, plots 44, and the “highly conductive” inks as utilized with the present invention, plots 46, are shown in FIG. 5.

For each given temperature, the plot of current density versus grid line resistance provides a curve that can be modeled as a straight line using conventional linear regression analysis tools. The slope of the curve-fitted line provides the current density to resistance ratio. As shown in FIG. 5, conventional conductive inks, having a sheet resistivity greater than 10 milliohms/square @ 25.4 μm (1 mil) exhibit a ratio of the current density to resistance (slope of curve fit analysis) less than 1 amp/ohm-mm², while the “highly conductive” inks applicable to the present invention, having a sheet resistivity less than about 8 milliohms/square @ 25.4 μm (1 mil), exhibit a ratio of the current density to resistance greater than 1 amp ohm-mm², with greater than about 2 amps/ohm-mm² being preferred, and greater than about 3 amps/ohm-mm² being especially preferred.

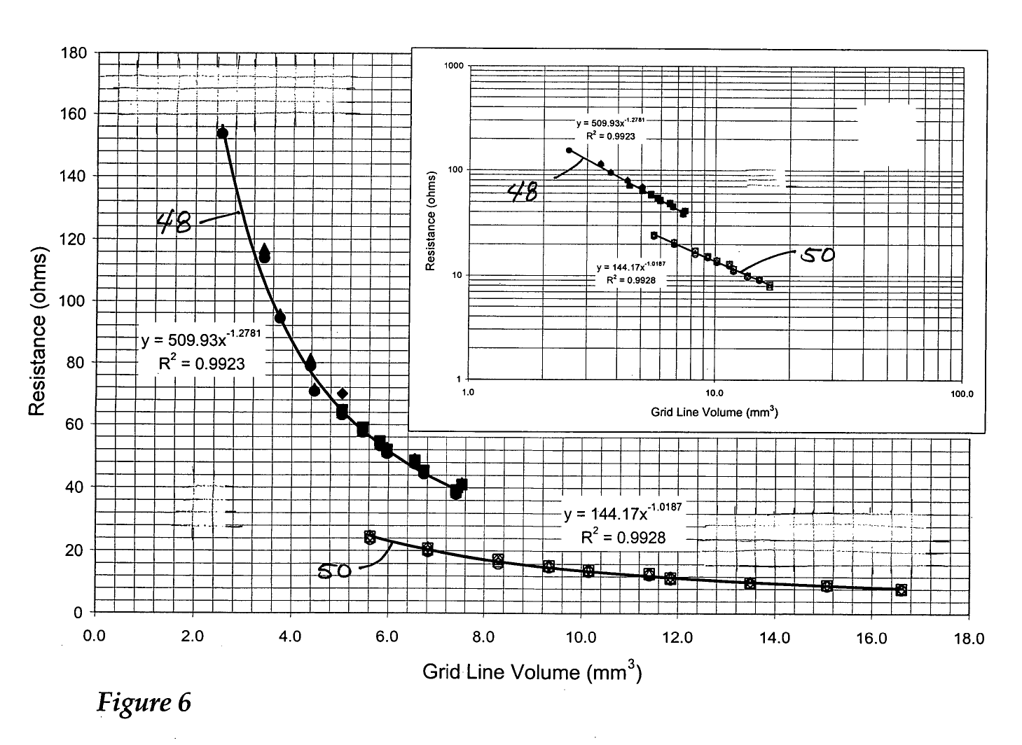

The inventors have also discovered that the measured grid line resistance data when plotted as a function of grid-line volume, can be modeled using a Power Law Function as shown in FIG. 6. As seen by plot 48, for grid-lines comprised of conventional silver inks, with a sheet resistivity greater than 10 milliohms/square @ 25.4 μm (1 mil), the constant of proportionality (y) is about 510, while the exponent associated with the Power Law Function is about −1.28. The grid lines comprised of the “highly conductive” inks exhibit a substantially different Power Law relationship having a constant of proportionality that is preferred to be less than 500, less than about 300 and even less than about 200. As seen in FIG. 6, this constant of proportionality is about 145. Similarly, the exponent associated with the Power Law Function for the “high conductivity” inks, a sheet resistivity of less than about 8 milliohms/square @ 25.4 μm (1 mil), is on the order of about −1.0. The applicability of a Power Law model to the measured data is demonstrated in the sub-graph of FIG. 6. A Power Law Function when plotted on a log-log graph will yield a straight line with the slope of the line representing the exponent or power of the function and the y-intercept being the constant of proportionality as shown.

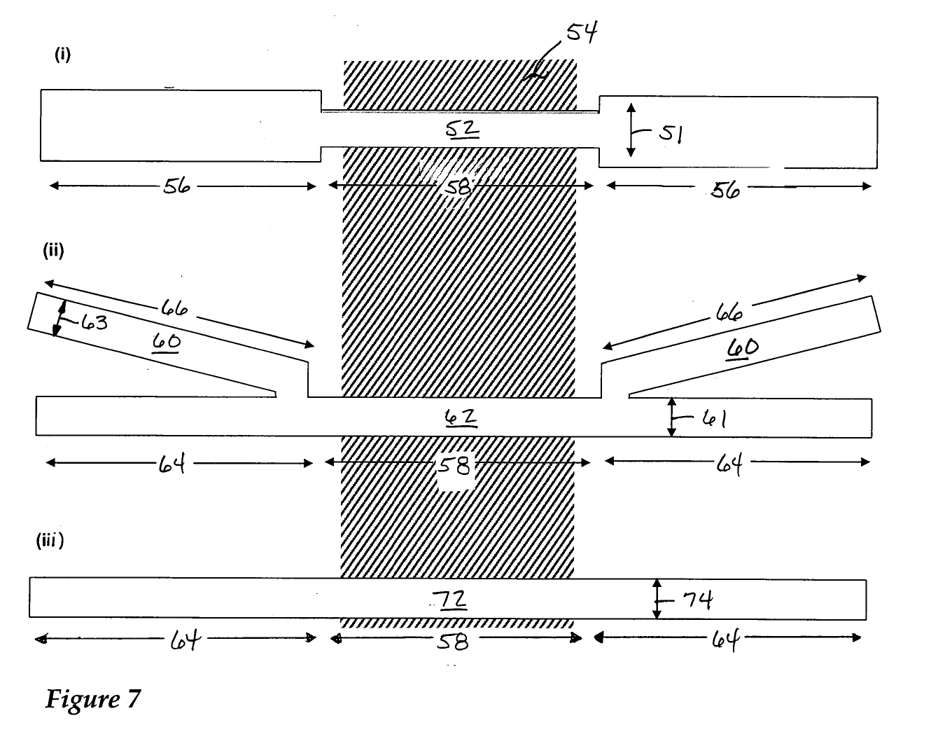

The inventors have discovered that the amount of current flowing through a primary grid line, or a segment of a primary grid line, can be enhanced by either using a “variable width” approach, a “converging line” approach, or a combination of both approaches. FIG. 7 provides for comparison of grid line exhibiting (i) the variable width approach, (ii) the converging line approach, and (iii) the conventional grid line 72 construction with no converging lines or changes in width 74.

The “variable width” approach includes decreasing the width 51 of a primary grid lines 52 upon entering a critical viewing area 54 of the plastic window assembly. The critical viewing area 54 is determined by the vehicle manufacturer based on the design of the vehicle. However, this critical viewing area 54 usually represents the area of the backlight observable by the driver when using the rearview mirror. In other words, the width 51 of a primary grid line 52 decreases at least one time between each busbar or end line segment 56 and the line segment 58 in the critical viewing area 54.

The “converging line” approach allows a secondary grid line 60 to intersect with a constant width 61 primary grid line 62 preferably outside the critical viewing 54 area or in a non-critical viewing area. In this approach, the width 61 of the end line segments 64 (of the primary grid line 62) when combined with the width 63 of the converging line segments 66 (of the secondary grid lines 60) is greater than the width 61 of center line segment 58 of the primary grid line 62. The enhancement in current flowing through the primary grid lines 52, 62 or segments 58 of the primary grid lines in the critical viewing area causes an associated increase in resistive heating of the grid line in that area, thereby reducing the amount of time necessary to defrost or defog a plastic window system.

The “variable width” approach can be used multiple times over the length of a primary grid line 52. In other words the width 57 of the primary grid line 52 may be reduced multiple times in order to optimize the current flow through the segment 58 of the primary grid line 52 in the critical viewing area 54. The current in the primary grid lines is best optimized if each step change in the width of the grid line is done symmetrically with respect to the opposing, left and right, ends of each primary grid line 52. Similarly, the use of a secondary line 60 in the “converging line” approach should also be done symmetrically with the use of a secondary grid line 60 on both the right and left end of the primary grid line 62. Both of these approaches have been shown to provide an increase in the current flowing through a primary grid line by greater than about 10%.

One example demonstrating the benefit of using either the “variable width” or “converging line” approaches for optimizing the amount of current is presented in Table 3, which utilized the grid lines depicted in FIG. 7. For this example, each of the grid line segments, identified as 58, 64, 66, and 56, have been respectively labeled and were printed using the high conductivity inks exhibiting a sheet resistivity of less than about 8 milliohms/square @ 25.4 μm (1 mil) at a thickness or height of about 9.0 μm. The length and width of each grid line segment is provided in Table 3. The resistance of each line segment was then determined along with the overall resistance approach for each grid line depicted in FIG. 7. The overall resistance of the “conventional” approach (iii) to grid line structuring was found to be the highest at 16.80 ohms, while the grid line using the “converging line” approach (ii) and the “variable width” approach (i) exhibited a smaller overall resistance at 12.06 ohms and 14.10 ohms, respectively. Upon the application of 13.1 volts, the current flowing through each of the primary grid lines was determined using Ohm's law to be on the order of 0.93, 1.09, and 0.78 amps for approach i, ii, and iii, respectively. Thus, both the “variable width” approach and the “converging line” approach are capable of increasing the current through the primary grid line in the critical viewing area by about 10% or more.

TABLE 3

| | | | Segment |
|---|---|---|---|
| Line | | | Resistance |
| Segment | Width (mm) | Length (mm) | (ohms) |
| A | 0.8 | 625 | 11.00 |
| B | 0.8 | 325 | 5.73 |
| C | 1.0 | 225 | 3.18 |
| D | 1.5 | 325 | 3.06 |

| | | Total | Current (amps) | |
|---|---|---|---|---|
| | Total # | Resistance | with 13.1 volts | Current |
| Approach | Segments | (ohms) | applied | Increase (%) |
| i | 2D + A | 14.10 | 0.93 | 19.1% |
| ii | 2B + 2C + A | 12.06 | 1.09 | 39.3% |
| iii | 2B + A | 16.80 | 0.78 | x |

As an alternative construction, the “variable width” approach may comprise multiple changes in the width of a printed grid line 52, thereby, establishing multiple zones that exhibit a difference in defrosting performance with respect to time. For example, if the width of a printed grid line 52 is reduced twice from each end, then a total of five zones are created with only three of these zones being different in defrost capability. Each reduction in grid line width may be abruptly done (stepping of the width) or gradually done over a length of several millimeters (tapering of the width). A continuous reduction in grid line width can also exhibit the same effect. In this particular embodiment, the portion of each grid line near the center of the critical viewing area, line segment 58, should have the smallest width, with the width of each grid line gradually becoming wider as one moves from the center of each grid line to both ends of each grid line (line segment 56).

The “converging line” approach (ii) may alternately comprise a secondary line 60 that crosses at least one primary grid line 62 prior to converging with another primary grid line 62, as well as multiple secondary lines 60 that converge with the same primary grid line 62. The secondary grid lines 60 may be of the same or a different width than the primary grid line 62. In addition, the secondary grid lines 60 may also exhibit a change in width over the length of the secondary grid line 60. Thus a secondary grid line 60 may also incorporate the use of the variable width approach over the length of the secondary grid line 60.

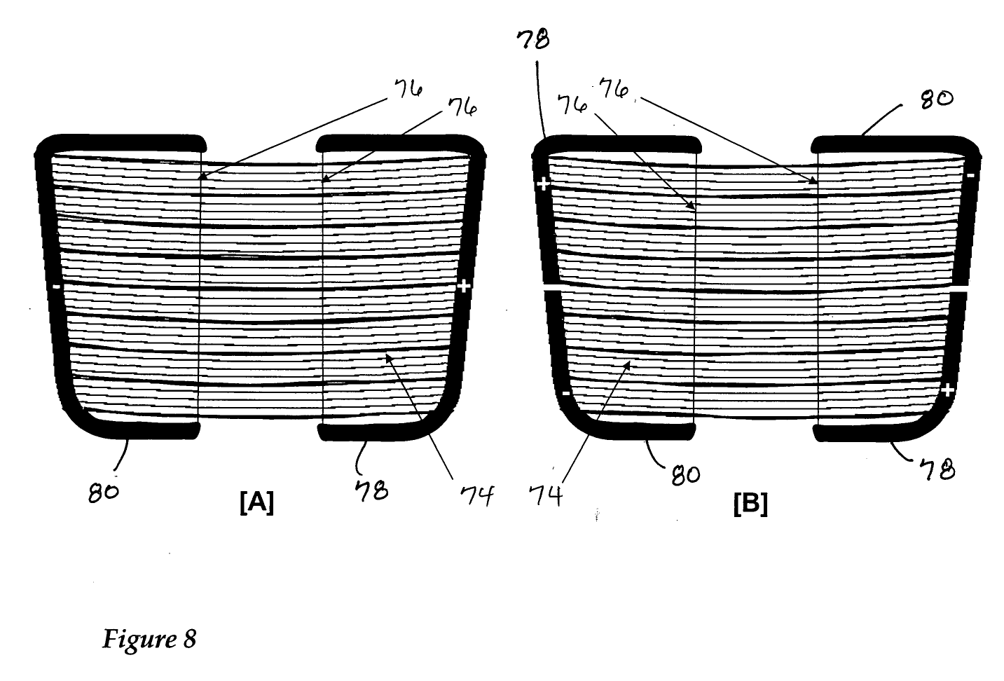

The inventors have also discovered that the amount of current flowing through a primary grid line 74 or a segment of a primary grid line 74 can be enhanced by using a “crossing line” approach as shown in FIG. 8. The “crossing line” approach allows a secondary grid line 76 to cross one or more primary grid lines 74, either in the critical viewing area or in a non-critical viewing area. The difference between the “crossing line” approach and the “converging line” approach is that the secondary line 76 does not converge with a primary grid line 74; rather the secondary line 76 in the “crossing line” approach originates at a first busbar 78 and ends with the intersection with either the same busbar 78 or with a second busbar 80. If more than two busbars 78, 80 are present in the defroster design, then the first and second busbars 78, 80 represent all negative and positive busbars, respectively. The secondary line 76 may cross a primary line 74 perpendicular to the primary line 74 (as shown) or at some other angle. The “crossing line” approach can be combined and used in conjunction with either the “variable width” or the “converging line” approaches or both.

The following specific examples are given to illustrate the invention and should not be construed to limit the scope of the invention.

### EXAMPLE 1

### Method for Measuring Sheet Resistivity

A grid line was printed onto a plastic substrate using a highly conductive ink applicable to the present invention. In this example, the highly conductive ink is a silver filled conductive ink identified as Exatec® 100/101 (Table 2). The printed ink was then thermally cured at about 129° C. for about 1 hour. The length of the grid line was measured using a micro-caliper, while the width of the grid line and the height of the grid line was measured using a profilometer. The overall electrical resistance of the grid line was also measured using an ohm meter. The measurements obtained for the grid line in this example are shown in Table 4 along with the calculations necessary to obtain the sheet resistivity value exhibited by the “highly conductive” ink.

First the number of squares present in the grid line is calculated by dividing the measured length of the grid line by the measured width of the grid line. The grid line in this example was found to exhibit 181.8 squares. Then the sheet resistivity is calculated by multiplying the measured resistance of the grid line by the measured height of the grid line adjusted to a reference height of 25.4 micrometers (1 mil) and subsequently dividing by the calculated number of squares. A sheet resistivity of 4.8 milliohms/square was obtained for the ink used in this example. Thus this example demonstrates the method utilized to determine the sheet resistivity exhibited by either conventional conductive or “highly conductive” inks.

TABLE 4

MEASURED
Grid line length = 200.0 mm
Grid line width = 1.1 mm
Grid line height = 9.41 micrometers
Grid line resistance = 2.375 ohms
CALCULATED
# squares = length/width = 200.0 mm/1.1 mm = 181.8 squares
Sheet Resistivity = (Resistance × (height/25.4 micrometers))/
# of squares
Sheet Resistivity = (2.375 ohms × (9.41 micrometers/25.4
micrometers))/181.8 squares
Sheet Resistivity = 0.0048 ohms/square = 4.8 milliohms/square.

### EXAMPLE 2

### Comparison of Conductive Inks

Thirteen conventional conductive inks were obtained from various manufacturers as shown in Table 2 along with three examples of highly conductive inks applicable to the present invention. A grid line was then printed onto a polycarbonate substrate using each of the different conductive inks. Each of the printed inks was then cured according to the manufacturer's recommended procedure. The highly conductive inks were cured for about 1 hour at about 129° C. The sheet resistivity value exhibited by each of the cured inks was then determined according to the method described in Example 1. The sheet resistivity exhibited by each of the conventional conductive silver inks and that of the highly conductive inks of are shown in Table 2. This example demonstrates that conventional conductive inks exhibit sheet resistivity values greater than or equal to 10 milliohms/square @ 25.4 μm (1 mil), while the highly conductive inks applicable to the present invention exhibit a sheet resistivity value less than about 8 milliohms/square @ 25.4 μm (1 mil), preferably less than about 6 milliohms/square @ 25.4 μm (1 mil).

### EXAMPLE 3

### “Variable Width” Approach

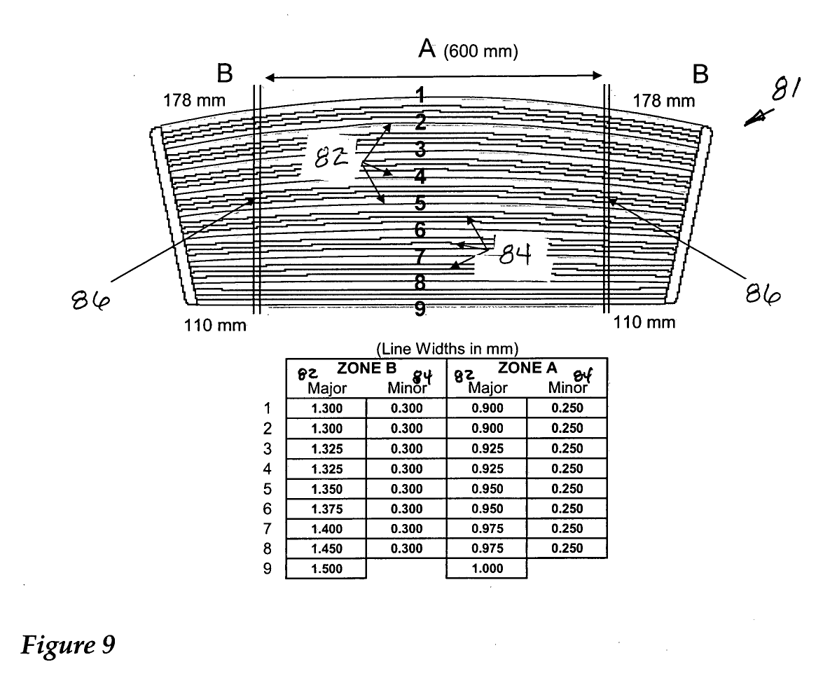

A heater grid was designed for a plastic window system that would fit on an automobile (a Sebring convertible, Chrysler Corporation) using the basic heater grid design described in U.S. patent application Ser. No. 10/847,250 filed on May 17, 2004, which is hereby incorporated by reference. This heater grid design 81 comprises both major and minor sets 82, 84 of grid lines, both of which could be considered as “primary” grid lines in the present invention provided their width is greater than 0.4 mm. The nine major grid lines 82 in the heater grid 81 ranged in width from about 0.9 to 1.5 mm, while the twenty-four minor grid lines 84 ranged in width from about 0.25 to 0.30 mm, as shown in FIG. 9. Thus, in this particular example, only the major grid lines 82 are considered to be primary grid lines as defined within the present invention. The defroster 81 was printed using a highly conductive ink (Exatec® 100/101) exhibiting a sheet resistivity less than about 8 milliohms/square @ 25.4 mm (1 mil). The current flow was optimized for this defroster by using the “variable width” approach, with the change in width generally occurring at double lines 86.

The width of all grid lines 82, 84 in the defroster design 81 were reduced once symmetrically from both ends of each grid line, thereby, creating two different heating zones, A and B, with zone B being replicated on each side of the defroster. The reduction in width varied between grid lines 82, 84, but was on the order of about 0.40 mm and 0.05 mm for the major 82 and minor grid lines 84, respectively, as shown in the table within FIG. 9. Zone A represents the zone considered as the critical viewing area. The major/primary grid lines ranged in length from 710 mm to about 778 mm with about 600 mm of each grid line residing in Zone A. The printed height of each grid line was measured to be on the order of 9 micrometers for the major primary grid lines 82 and about 11 micrometers for the minor grid lines 84.

After the defroster 81 was printed on the surface of a 4 mm thick polycarbonate substrate, it was thermally cured at 129° C. for 1 hour and subsequently coated with the Exatec® 900 Glazing System (Exatec LLC, Wixom, Mich.). The defrost characteristics of the heater grid was tested according to SAE J953 protocol and found to defrost about 75% of the entire viewing area in about 8 minutes.

The flow of electrical current established in the major grid lines 82 upon the application of 13.1 volts by enhancing the electrical current via the “variable width” approach is shown in Table 5. For comparative purposes, the current flow for the same defroster design without any line width changes in Zone B is also provided in Table 5 and identified as a conventional defroster approach. In the conventional approach the grid line width established in Zone A was held constant throughout Zone B.

TABLE 5

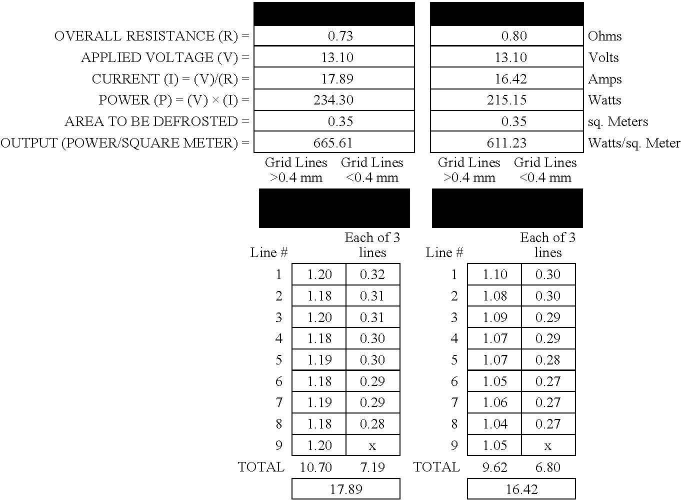

The electrical current flowing through each of the nine major grid lines 82 averaged about 1.19 amps when using the “variable width” approach. as shown in Table 5. In comparision, identical major grid lines using the conventional approach (no change in line width) exhibited an average of 1.07 amps of current flow under similiar conditions. Thus, the “variable width” approach of this example demonstrates about a 10% increase (˜0.12 amps) in the amount of current flowing through each of the major grid lines 82. Similarly, about a 10% increase in current flow is observed in the minor grid lines 84 by using the “variable width” approach (average=0.03 amps) as compared to the to conventional approach (average=0.28 amps). However, the small increase of 0.02 amps in the minor grid lines 84 (having a width less then 0.40 mm) was not large enough to provide the substantial increase in resistive heating as observed for the major grid lines 82.

This example further demonstrates that the heater grid according to the present invention can exhibit an overall pattern resistance less than about 1 ohm, preferably less than about 0.8 ohms as shown in Table 5. In addition, the power output of the heater grid is greater than about 200 Watts, which provides greater than about 600 Watts/meter² of viewing area.

### EXAMPLE 4

### “Converging Line” Approach

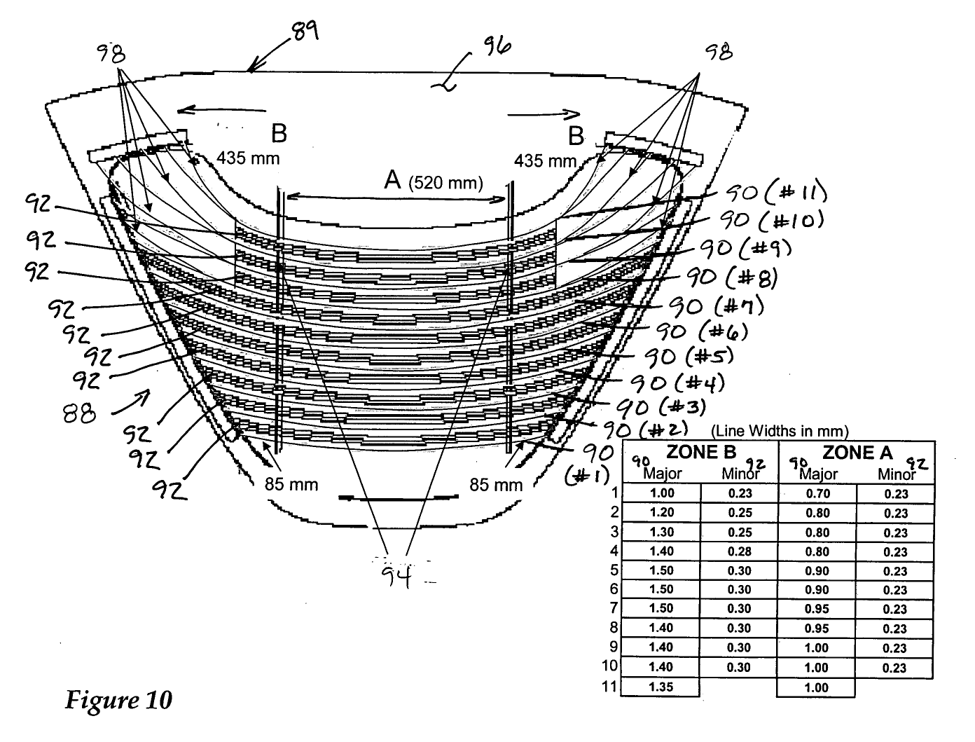

A heater grid 88 according to the present invention was designed for a plastic window system that would fit an automobile (Corvette, General Motors Co.) using the heater grid configuration generally described in U.S. patent application Ser. No. 10/847,250 filed on May 17, 2004. This heater grid 88 included both major and minor sets of grid lines 90, 92, both of which can be considered as primary grid lines for the present invention, provided the width of the grid line is greater than 0.4 mm. The eleven (11) major grid lines 90 ranged in width from about 0.70 to 1.50 mm, while the thirty (30) minor grid lines 92 ranged in width from about 0.23 to 0.30 mm, as shown in the table of FIG. 10. Thus, in this particular example, only the major grid lines 90 are considered as primary grid lines as defined within the present invention. The heater grid 88 was printed using a “highly conductive” ink exhibiting a sheet resistivity less than about 8 milliohms/square @ 25.4 μm (1 mil) in order to enhance current flow. The current flow was further optimized for this defroster by using both the “variable width” approach and the “converging line” approach, as discussed above, to enhance the current flow in the critical viewing area (Zone A) as shown in FIG. 10.

The “converging line” approach was used with the longest major grid lines 90 (line #'s 8-11, FIG. 10). The “variable width” approach was used for all of the major 90 and minor grid lines 92. The width of all grid lines in the defroster design were reduced once, symmetrically from each end of the grid line generally at double line 94, thereby, creating two different heating zones, A and B, with zone B being replicated on each side of the defroster. The reduction in width varied between grid lines, but was on the order of about 0.45 mm and 0.07 mm for the major 90 and minor grid lines 92, respectively, as shown in FIG. 10. The grid lines 90, 92 ranged in length from 689 mm, to about 1391 mm, with about 520 mm of each grid line residing in Zone A. The printed height of each grid line was measured to be on the order of 9 micrometers for the major grid lines 90 and about 11 micrometers for the minor grid lines 92.

After the heater grid 88 was printed on the surface of a 4 mm thick polycarbonate substrate 96, it was thermally cured at 129° C. for 1 hour and subsequently coated with the Exatec® 900 Glazing System (Exatec LLC, Wixom, Mich.). The defrost characteristics of the heater grid 88 were tested according to SAE J953 protocol and found to defrost about 75% of the entire viewing area in about 10 minutes.

A comparison of the current flow established in the critical viewing area (Zone A) for the both the primary 90 and minor grid lines 92 using three different approaches, (a) a “converging line and variable width approach”, (b) a “variable width approach” only, and (c) a “conventional approach” (no variation in grid line width), is shown in Table 6.

The “variable width approach” is shown to enhance the current flowing through all of the major 90 and minor grid lines 92 by about 10% over the “conventional approach”. The current in the major grid lines 90 is observed to increase by about 0.2 amps upon using the “variable width approach”. However, the small increase of 0.02 amps in the minor grid lines 92 (width less than 0.40 mm) is not large enough to provide the substantial increase in resistive heating as observed for the major grid lines 90.

The use of the “converging line and variable width approach”, in connection with the major grid line 90 (#'s 8-11), further enhanced the current flow through each of these grid lines 90 by approximately an additional 30%. No further enhancement was observed in any of the grid lines 92 (#'s 1-7) that did not incorporate a converging line 98. Each of the converging grid lines 98 were printed using the same width as the major grid line 90 in Zone B that it was intended to converge with.

TABLE 6

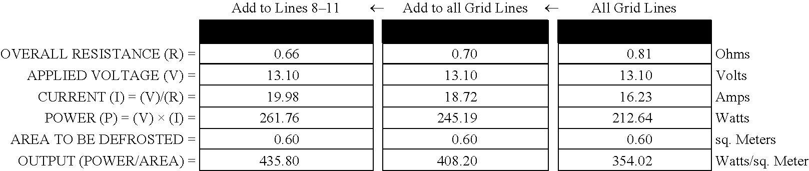

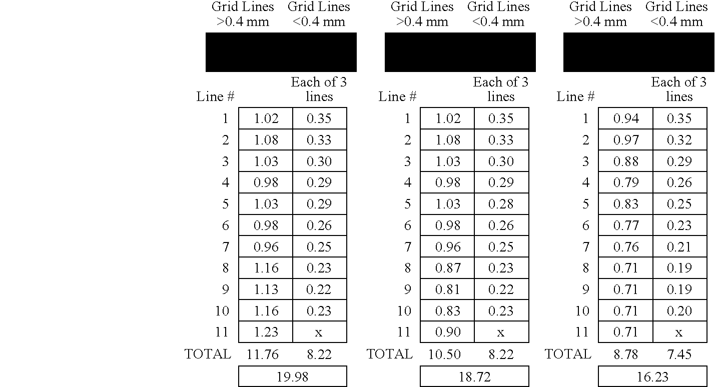

This example further demonstrates that the heater grid 88 according to the present invention with a “highly conductive” ink exhibiting a sheet resistivity less than about 8 milliohms/square @ 25.4 μm (1 mil) can exhibit an overall pattern resistance less than about 1 ohm, preferably less than about 0.8 ohms as shown in Table 6. In addition, the power output of the heater grid 88 is greater than about 200 Watts, which provides greater than about 400 Watts/meter² of viewing area.

### Example 5

### “Crossing Line” Approach

A heater grid, not shown, was constructed for a plastic window system that would fit an automobile and included 17 primary grid lines exhibiting a width of about 0.50 mm, a height of about 6.0 μm and a length of about 1,100 mm in length. The defroster was printed using a “highly conductive” ink applicable to the present invention and exhibiting a sheet resistivity less than about 8 milliohms/square @ 25.4 μm (1 mil) in order to enhance current flow. The current flow was further optimized for this defroster by using the “crossing line” approach to enhance the current flow in the critical viewing area. In this respect, two secondary lines were printed that crossed all of the primary grid lines at about a 90° angle prior to intersecting with the same busbar from which the secondary line originated, similar to that as depicted in FIG. 8A. The secondary lines were about 0.6 mm in width and about 30 μm in height.

After the defroster prototype was printed on the surface of a 4 mm thick polycarbonate substrate, it was thermally cured at 129° C. for 1 hour. A thermal profile of the heater grid, both with and without the use of the “crossing line approach” was performed through the use of an IR camera. Upon the application of 13.1 volts to the conventional heater grid (without any secondary lines), the current flow through the entire heater grid was found to be 5.2 amps, resulting in only a small elevation in the temperature of the primary grid lines from ambient temperature (22.5° C.) to about 33° C. However, the heater grid utilizing the “Crossing Line” Approach was found to increase the overall current flow through the heater grid to about 10 amps with the temperature of the primary grid line segments in the center of the window, between the two secondary lines, exhibiting a temperature between 65-70° C.

This example demonstrates the ability of the “Crossing Line” Approach to enhance the current in a segment of the primary grid lines resulting in greater resistive heating (higher thermal output, i.e., temperature).

A person skilled in the art will recognize from the previous description that modifications and changes can be made to the preferred embodiment of the invention without departing from the scope of the invention as defined in the following claims. A person skilled in the art will further recognize that all of the measurements described in the preferred embodiment are standard measurements that can be obtained by a variety of different test methods.

What is claimed is:

1. A plastic window and defroster assembly comprising:
a transparent plastic panel;
a conductive heater grid supported by the transparent panel and formed a conductive ink and having a plurality of primary grid lines, opposing ends of each of the grid lines being connected to a first and a second busbar, the conductive ink exhibiting a sheet resistivity less than about 8 milliohms/square @ 25.4 μm (1 mil), the resistance the primary grid lines being less than about 30 ohms and the overall resistance of the heater grid being less than about 1 ohm; and
at least one electrical connection to the first and second busbars adapted to establish a closed electrical circuit.

2. The plastic window and defroster assembly of claim 1 wherein the sheet resistivity of the conductive ink is less than about 6 milliohms/square @ 25.4 μm (1 mil).

3. The plastic window and defroster assembly of claim 1 wherein the overall resistance of the heater grid is less than about 0.8 ohms.

4. The plastic window and defroster assembly of claim 1 wherein each of the primary grid lines has a resistance of less than about 25 ohms.

5. The plastic window and defroster assembly of claim 1 wherein the transparent plastic panel is formed of a plastic resin and the plastic resin is a polycarbonate resin, acrylic resin, polyarylate resin, polyester resin, or polysulfone resin, a copolymer resin or a mixture thereof.

6. The plastic window and defroster assembly of claim 1 further comprising a protective layer of a plastic film, an organic coating, or an inorganic coating.

7. The plastic window and defroster assembly of claim 6 wherein the plastic film is of the same composition as the transparent plastic panel.

8. The plastic window and defroster assembly of claim 6 wherein the organic coating is a urethane, epoxide, acrylate, or a blend thereof.

9. The plastic window and defroster assembly of claim 6 wherein the inorganic coating is comprised of one or more selected from the group comprising silicones, aluminum oxide, silicon monoxide, silicon dioxide, silicon nitride, silicon oxy-nitride, silicon oxy-carbide, silicon carbide, titanium oxide, indium tin oxide, zinc oxide, zirconium oxide, zirconium titanate, or glass.

10. The plastic window and defroster assembly of claim 6 wherein the protective layer is a multilayer coating system.

11. The plastic window and defroster assembly of claim 10 wherein the multilayer coating system includes an acrylic coating, a silicone coating, and a SiOₓC_{y}H_{z} coating.

12. The plastic window and defroster assembly of claim 1 wherein the conductive ink includes conductive particles dispersed in a carrier medium.

13. The plastic window and defroster assembly of claim 12 wherein the conductive particles are at least one of silver, silver oxide, copper, zinc, aluminum, magnesium, nickel, tin and alloys thereof.

14. The plastic window and defroster assembly of claim 12 wherein the conductive particles have a size of less than about 40 μm.

15. The plastic window and defroster assembly of claim 12 wherein the conductive ink includes a polymeric binder.

16. The plastic window and defroster assembly of claim 15 wherein the polymeric binder is an epoxy resin, a polyester resin, a polyvinyl acetate resin, a polyvinylchloride resin, a polyurethane resin, a copolymer or blend thereof.

17. The plastic window and defroster assembly of claim 15 wherein the polymeric binder is soluble in the carrier medium.

18. The plastic window and defroster assembly of claim 1 wherein the conductivity ink further includes an additive being a metallic salt, metallic compound, metallo-decomposition product, or mixture thereof.

19. The plastic window and defroster assembly of claim 18 wherein the metallic salt is a tertiary fatty acid silver salt.

20. The plastic window and defroster assembly of claim 18 wherein the metallic compound is metallic carbonate, metallic acetate compounds, or a mixture thereof.

21. The plastic window and defroster assembly of claim 18 wherein the metallo-organic decomposition product is a carboxylic acid metallic soap, silver neodecanoate, gold amine 2-ethylhexanoate, or mixtures thereof.

22. The plastic window and defroster assembly of claim wherein the conductive heater grid is adhered directly onto a surface of the transparent plastic panel.

23. The plastic window and defroster assembly of claim 1 wherein the conductive heater grid is adhered directly onto a surface of a protective layer.

24. The plastic window and defroster assembly of claim 1 wherein the conductive heater grid further comprises at least one secondary grid line having one end connected to of the first and second busbars and another end connected to one of the primary grid lines.

25. The plastic window and defroster assembly of claim 24 wherein the secondary grid line crosses at least one of the primary grid lines.

26. The plastic window and defroster assembly of claim 1 wherein the width of a primary grid line decreases at least one time the ends of the primary grid line and a midpoint of the primary grid line.

27. The plastic window and defroster assembly of claim 1 wherein the conductive heater grid further includes at least one secondary grid line with one end connected to the first busbar and another end connected to one of the first and second busbars.

28. The plastic window and defroster assembly of claim 27 wherein the secondary grid line crosses at least one of the primary grid lines.

29. A method of defrosting and defogging the surface of a plastic window and defroster assembly comprising:
applying a voltage to a printed conductive heater grid of a cured conductive ink causing electrical current to flow through primary grid lines of the conductive heater grid;
causing resistive heating of the primary grid lines via a flow of electrical current through a segment of the primary grid lines being greater than about 0.4 amps and wherein the ratio of current density to resistance for the primary grind lines is greater than about 1 amp/ohm-mm²;
causing a surface of a transparent plastic glazing panel to defrost and defog via the resistive heating of the primary grid lines causing; and
disconnecting the voltage from the heater grid after the surface of the transparent plastic glazing panel is defrosted and defogged.

30. The method of claim 29 wherein the flow of electrical current through a segment of the primary grid lines is provided at greater than about 0.7 amps.

31. The method of claim 29 wherein the flow of electrical current through a segment of a primary grid lines is provided at greater than about 0.85 amps.

32. The method of claim 29 wherein the flow of electrical current through a segment of a primary grid lines is provided at greater than about 1.0 amps.

33. The plastic window and defroster assembly of claim 29 wherein heater grid is printed with a conductive ink is cured to exhibit a sheet resistivity of less than about 8 milliohms/square @ 25.4 μm (1 mil).

34. The plastic window and defroster assembly of claim 33 wherein the conductive ink is cured to exhibit a sheet resistivity of less than about 6 milliohms/square @ 25.4 μm (1 mil).

35. The plastic window and defroster assembly of claim 29 wherein current is provided such that the ratio of current density to resistance for a segment of the primary grid lines is greater than about 2 amps/ohm-mm².

36. The plastic window and defroster assembly of claim 29 wherein current is provided such that the ratio of current density to resistance for a segment of a primary grid line is greater than about 3 amps/ohm-mm².

37. The plastic window and defroster assembly of claim 29 wherein a primary grid line of the conductive heater grid is provided with a width greater than about 0.4 mm.

38. The plastic window and defroster assembly of claim 29 wherein a primary grid line is formed to exhibit a thermal ratio that is equal to or greater than 1.8.

39. The method of claim 29 wherein a primary grid line is formed to exhibit a thermal ratio that is equal to or greater than 2.0.

40. The method of claim 29 wherein a primary grid line is formed to exhibit a thermal ratio that is-equal to or greater than 2.2.

41. The method of claim 29 wherein the conductive ink comprises metallic particles.

42. The method of claim 41 wherein the metallic particles comprise one selected from silver, silver oxide, copper, zinc, aluminum, magnesium, nickel, tin, or mixtures and alloys of the like.

43. The method of claim 41 wherein the conductivity ink further comprises an additive selected from metallic salts, metallic compounds, metallo-decomposition products, or mixture or blend thereof.

44. The method of claim 29 wherein the conductive heater grid is formed having at least one secondary grid line with one end of the grid line connected to a busbar and the other end connected to a primary grid line.

45. The method of claim 44 wherein the secondary grid line crosses at least one primary grid line.

46. The method of claim 29 wherein the width of a primary grid line is caused to decrease at least one time between the center of the primary grid line and each end of the primary grid line.

47. The method of claim 29 wherein the conductive heater grid is formed having at least one secondary grid line with one end of the grid line connected to the first busbar and the other end connected to a busbar selected from the first and second busbars.

48. The method of claim 47 wherein the secondary grid line crosses at least one primary grid line.

49. The method of claim 29 wherein the transparent plastic glazing panel is formed including a transparent plastic panel and at least one protective layer.

50. The method of claim 49 wherein the protective layer comprises one selected from a plastic film, an organic coating, or an inorganic coating.

51. The method of claim 49 wherein the transparent plastic panel comprises a plastic resin selected from polycarbonate resins, acrylic resins, polyarylate resins, polyester resins, or polysulfone resins.

52. The method of claim 49 wherein the conductive heater grid is printed directly onto the surface of the transparent plastic panel.

53. The method of claim 49 wherein the conductive heater grid is printed directly onto the surface of a protective layer.
